(19) United States
(12) Patent Application Publication
(10) Pub. No.: US 2013/0326487 A1
(43) Pub. Date: Dec. 5, 2013

(54) EMULATING CLOUD FUNCTIONING OF APPLICATIONS LOCALLY

(71) Applicants: SHENOL YOUSOUF, Sofia (BG); Petio Petev, Sofia (BG); Georgi Stanev, Sofia (BG)

(72) Inventors: SHENOL YOUSOUF, Sofia (BG); Petio Petev, Sofia (BG); Georgi Stanev, Sofia (BG)

(21) Appl. No.: 13/484,363

(22) Filed: May 31, 2012

(51) Int. Cl. G06F 9/455

(52) U.S. Cl. 717/134

(57) ABSTRACT

In one aspect, an application is received to be to be executed in a local development environment. The application is configured to access at least one service from a number of services of a remote runtime platform. A software development kit (SDK) is selected as an execution environment of the application. The SDK includes a number of application programming interfaces (APIs) of the services and a number of local implementations of the services. In another aspect, the application is executed over the SDK and remote functioning of the application is emulated in the local development environment.

### BACKGROUND

Cloud computing is a widely adopted concept. Generally, cloud computing refers to a model for enabling ubiquitous, convenient, and on-demand access to shared pools of configurable computing resources such as networks, servers, storages, applications, functionalities, and the like. There are a number of benefits associated with cloud computing for both the providers of the computing resources and their customers. For example, customers may develop and deploy various business applications onto a cloud infrastructure supplied by a cloud provider without the cost and complexity to procure and manage the hardware and software necessary to execute the applications. The customers do not need to manage or control the underlying cloud infrastructure, (e.g., network, servers, operating systems, storage, etc.), but still have control over the deployed applications and possibly over the configuration settings of the application-hosting environment. On the other hand, the provider's computing resources are available to provide multiple customers with different physical and virtual resources dynamically assigned and reassigned according to clients' load.

Typically, cloud providers offer common computing resources as services to their customers. Generally, these services are common functionality that can be used by customers' applications. Examples of such common functionality that can be offered as services by cloud providers include, but are not limited to, persistence service, connectivity service, identity management service, and the like. Customers enrich their business applications with services offered by cloud providers. Providers may supply these services as demanded and requested by their customers to meet their specific needs and requirements. On one hand, the services are provisioned by the cloud infrastructure and are consumed by the customers' applications once the applications are deployed onto the cloud infrastructure. On the other hand, customers of cloud services are faced with the problem of ensuring proper functioning of their applications when deployed onto the cloud infrastructure. For this reason, customers may need to test and validate their business applications locally before deploying the applications onto the cloud infrastructure.

Cloud providers may offer to their customers, a micro cloud for local testing. One example is Micro Cloud Foundry™ offered by VMware®, Inc. However, a micro cloud necessitates installation of a version of the cloud platform on the application developer's computer system. This may result in a higher total cost of ownership, since redundant resources may be consumed.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 illustrates an exemplary computer system landscape for deploying customer applications onto cloud infrastructure, according to one embodiment.

FIG. 2 illustrates a system landscape for local and remote development of applications, according to one embodiment.

FIG. 3 illustrates a process for emulating in a local development environment the functioning of an application on a remote runtime platform, according to one embodiment.

FIG. 4 illustrates an exemplary computer system landscape with a local development runtime platform configured as an execution environment for an application to be deployed onto a remote runtime platform, according to one embodiment.

FIG. 5 illustrates an exemplary computer system landscape with installed local development runtime platform as an execution environment for an application to be deployed onto a remote runtime platform, according to one embodiment.

FIG. 6 is a block diagram of an exemplary computer system to execute computer readable instructions for emulating locally cloud functioning of application, according to one embodiment.

### DETAILED DESCRIPTION

Embodiments of techniques for emulating cloud functioning of applications locally are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

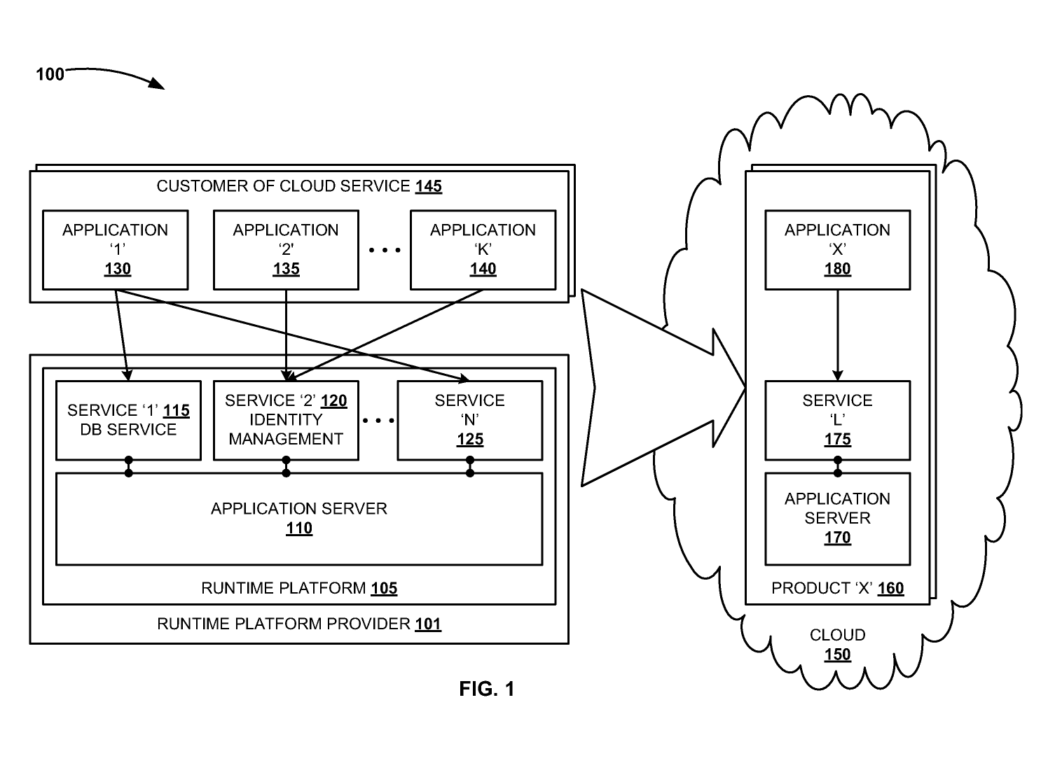

FIG. 1 shows an exemplary computer system landscape 100 for deploying customer applications onto cloud infrastructure, according to one embodiment. Runtime platform 105 may be developed and maintained by runtime platform provider 101. There are a number of vendors that provide commercial runtime platforms. Just as an example, SAP AG provides SAP® NetWeaver® Cloud, a Java® based Platform-as-a-Service offering that makes it possible for partners and customers of SAP AG to deploy and use Java® applications in a cloud environment.

In one embodiment, runtime platform 105 is a cloud infrastructure. As such, the runtime platform may exhibit typical properties of a cloud infrastructure such as resource pooling where the computing resources of the cloud infrastructure provider are pooled to serve multiple consumers using a multi-tenant model. Another characteristic that the runtime platform may exhibit is elasticity that refers to the capability of the platform to elastically provision and release computing resources to scale commensurate with demand. The runtime platform may also expose a metering characteristic that refers to the capability of the cloud infrastructure to automatically control, monitor, report and optimize resource usage at some level of abstraction appropriate to the type of service, for example, storage, processing, bandwidth, and active user accounts, and so on.

A cloud infrastructure or cloud environment may refer to the collection of hardware and software that enables essential characteristics of cloud computing. The cloud infrastructure can be viewed as containing both a physical layer and an abstraction layer. The physical layer may consist of the hardware resources that are necessary to support the cloud services being provided, and may typically include server, storage, network components, and so on. The abstraction layer may consist of the software deployed across the physical layer, which manifests the essential cloud characteristics. Conceptually, the abstraction layer is above the physical layer.

In one embodiment, runtime platform 105 includes application server 110 as a core part for building runtime environment based on the runtime platform 105. For example, the application server may be a Java® application server for executing Java® based applications such as a Lean Java® Server (LJS). In another example, the application server 110 may be a webserver to provide environment for execution of web based applications. Runtime platform 105 may further include virtual machine such as Java® Virtual Machine (JVM).

In one embodiment, the runtime platform 105 may include a number of services 115-125 which provide additional runtime functionality that the applications 130-140 may be configured to access and consume. A service may be any type of functionality or feature that may be accessed and used by applications 130-140 and other such services. Services may be logical entities that may be distinctly used, imported, accessed or otherwise referenced. Various types of computing resources may be represented as services. One example of a service may be a persistency or database service such as illustrated service ‘1’ 115. The persistency service may provide access to a relational database for applications 130-140 to be deployed and hosted on cloud 150. The persistence service 115 may provide a default schema in which tables can be created and data stored for one or more applications from applications 130-140 that are configured to use the service. The persistence service may provide connection parameters, such as URLs, drivers, and users, and also may perform other tasks such as backup and recovery, load balancing, and scaling.

Another example of a service may be identity management such as illustrated service ‘2’ 120. The identity management service may provide a central user store for identities that require access to protected resources of one or more applications from applications 130-140 that are configured to use the service once deployed and installed on cloud 150. The identity management service may also provide a single sign-on (SSO) access to users of applications 130-140 that are configured to use the identity management service. Other examples may include, but are not limited to, connectivity service that provides a secure and reliable access to applications, document service that provides a content repository for unstructured or semi-structured content, mail service that may enable transmission of electronic mail messages from applications that are configured to access, import, or otherwise use the service, and the like. In one aspect, the runtime platform 105 may also be supplied and offered by the runtime platform provider 101 as a service.

In one embodiment, a service may be associated with two parts, an application programming interface (API) of the service and an implementation of the service. The API of a service is the part of the service that is directly imported and referenced by an application that is to be deployed and installed on a runtime platform. Thus, the implementation of the service may be modified without affecting how the service is referenced and used. The API of the service is used by the application and possibly by other services. Services may expose different types of APIs. Examples include, a standard Java® API, a tailored to the service Java® API, Representational state transfer (REST) API, and the like. In one embodiment, a service may not expose an API. The API part associated with a service is optional. For example, if the service is not intended to be consumed by applications or, if the service is configured to functionally depend on the service without explicit reference to an API. Table 1 below illustrates a Java® interface that represents a service API.

TABLE 1
Service API

package com.sap.jpaas.service.example.api;
/**
* This class is an example API for JPaaS Service.
*/
public interface ExampleService {

/**
* A sample method that says hello.
*
* @param name - it will be included in the response
* @return greeting
*/
public String hello(String name);

}

In various embodiments, an application may access a service via an API of the service. Thus, typically, the application is configured to access only the API of the service, without having access to the full implementation of the service. However, the implementation part of the service is also required for the application to work properly when deployed and installed on the cloud or other runtime platform. Respectively, an implementation part of the service is also necessary for testing and validating an application that is configured to access at least one service of a remote runtime platform. In one embodiment, in order to test and emulate functioning of the application that is to be deployed and installed on a remote runtime platform, local implementations of services may be consumed.

In one embodiment, for local development of applications, local implementations of the services of the runtime platform may be developed and used. Local development of applications may refer to the applications' development environment such as an integrated development environment (IDE). Alternatively, remote implementations of services may be used and accessed for actually deployed, installed, and provisioned applications on a cloud infrastructure or other remote runtime platform. In one embodiment, APIs of services of the remote runtime platform are common for both the local and the remote service implementations.

Local service implementations are intended for use while developing applications in the IDE. The local implementations of the services are mock implementations of remote implementations of the services. The provided local implementations of services emulate remote implementations of cloud services sufficiently so as to enable effective and reliable testing of the developed application in the local development environment. The level of emulation enables the application to achieve the same results in the local development environment as if it is deployed and provisioned on the remote runtime platform. Thus, testing and validating of the application before deployment on the remote runtime platform is effective and reliable, since the same results apply before and after deployment on the remote runtime platform. It is possible to validate and test proper working of an application in the local development environment before it is deployed and provisioned on the remote runtime platform.

If a service provides an API, the local service implementation implements this API. Local service implementations do not depend on the remote runtime platform. Thus, the local service implementations are functional and can be consumed even if the local host computer is offline. Table 2 below illustrates local implementation of the service API illustrated in Table 1.

TABLE 2
Local service implementation

package com.sap.jpaas.service.example.local;
import com.sap.jpaas.service.example.api.*;
public class ExampleServiceImpl implements ExampleService {

@Override
public String hello(String name) {

return “Hello, ” + name;

}

}

Remote service implementations are intended for use of actually hosted and provisioned application on the cloud infrastructure or other remote runtime platform. The remote service implementations are the service implementations that are consumed and are running on the remote runtime platform. Generally, local and remote implementations differ. Alternatively it is possible that both implementations are the same. If the service provides an API, the remote service implementation implements the API. Table 3 below illustrates a remote implementation of the service API illustrated in Table 1.

TABLE 3
Remote service implementation

package com.sap.jpaas.service.example.central;
import com.sap.jpaas.service.example.api.*;
public class ExampleServiceImpl implements ExampleService {

public String hello(String name) {

return “Hello from the cloud, ” + name;

}

}

A customer of cloud services may develop and deliver one or more applications to be executed in a cloud environment. The functionality provided by such applications may be accessed on the cloud by a number of consumers, e.g., related to the customer. As illustrated in FIG. 1, applications 130-140 are delivered by one or more customers 145, e.g., of the runtime platform provider 101. The different applications 130-140 may require, use, and depend on different runtime components for their execution. For example application ‘1’ 130 may be configured to access services ‘1’ 115, ‘2’ 120 and ‘N’ 125, while applications ‘2’ 135 and ‘K’ 140 may be configured to access just service ‘2’ 120. In one embodiment, the applications 130-140 provided by one or more of customers 145 may be configured to access different subsets of the components of the runtime platform 105. The different subsets may have a common intersection, e.g., application server 110 and a subset of the services 115-125 required by all applications 130-140. As illustrated in FIG. 1, customers 145 may use one or more of the offered services 115-125 based on the specific requirements of the developed applications 130-140. Thus, customers 145 may reuse and utilize common functionalities and computing resources that are already offered by runtime platform provider 101. The availability of services on-demand frees customers 145 from the responsibility to provide and manage the utilized platform functionality and enables customers 145 to focus on developing the business logic of the applications 130-140.

In one embodiment, applications 130-140 run onto and are processed in the cloud 150 as modules. For example, an application from applications 130-140 may be processed as module in application server 170, e.g., a runtime container such as US. The server itself may run on a virtual machine. In various embodiments, applications 130-140 consume and are configured to access services 115-125. Services 115-125 are centrally provided by runtime platform 105 and are accessed and consumed by applications 130-140.

In one embodiment, a consumer request or another event may invoke the execution of a customer application in a cloud environment. According to the characteristics of the cloud environment, the invocation of the application may cause its provisioning, installation and starting, together or after the deployment of the necessary runtime platform. FIG. 1 illustrates customer application ‘X’ 180 deployed on cloud 150 together with application server 170 and service ‘L’ 175. For example, application server 170 may include a subset of the components of application server 110 that are necessary for executing application ‘X’ 180 Similarly, service ‘L’ 175 may be one of services 115-125 that is required and used by the application ‘X’ 180.

Typically, application ‘X’ 180, service ‘L’ 175 and application server 170 are described or merged together in product ‘X’ 160, according to one embodiment. The definition of product ‘X’ 160 may be based on the characteristics and the requirements of the application ‘X’ 180. The packaging of application ‘X’ 180 together with the prerequisite runtime platform components, e.g., application server 170 and service ‘L’ 175, facilitates the installation of the application ‘X’ 180 on the cloud 150. In one embodiment, the remote service implementation of service ‘L’ 175 is consumed once application ‘X’ 180 is deployed, installed, and provisioned on cloud 150.

In one embodiment, the required services are determined in order to package application ‘X’ 180 together with the prerequisite runtime platform components. According to one embodiment, only the necessary services together with other prerequisite platform components and the application are installed on cloud 150. Thus, no redundant computing resources are consumed. For example, instead of installing all available services 115-125 only service ‘L’ 175 is installed together with application ‘X’ 180.

There are different technology solutions that implement provisioning of applications to cloud environment together with a base product, e.g., the runtime platform such as runtime platform 105. One example for such technology includes p2® provisioning platform for Eclipse®-based applications. Eclipse® is an open source community, whose projects are focused on building an open development platform composed of extensible frameworks, tools and runtimes for building, deploying and managing software across lifecycle. The p2® platform is part of the Equinox® project of Eclipse®. An Eclipse®-based product is a stand-alone program, e.g., self-contained and installable software application, built using the Eclipse® development platform. In one embodiment, Eclipse® provisioning mechanism p2® may be utilized to generate, validate and install product ‘X’ 160 based on the definitions of application ‘X’ 180 provided by customer 145, and further based on the definitions of runtime platform 105.

In one embodiment, a service may be represented as an Eclipse® feature. A feature may correspond to a particular functionality of the application, and usually groups a number of unitary software components that could be managed together as a single entity. According to the terminology adopted in Eclipse® projects, such unitary software components are called plugins. The plugins are the basic installable and executable units or software code structures. Usually, a package representing the API and another package representing the implementation are grouped in one feature representing the service. Examples of such packages include, but are not limited to, Java® packages represented by Java® Archive (JAR) files, bundles such as Open Services Gateway initiative (OSGi™) files similar to JAR files, Web Archive (WAR) files, plugins, and other features.

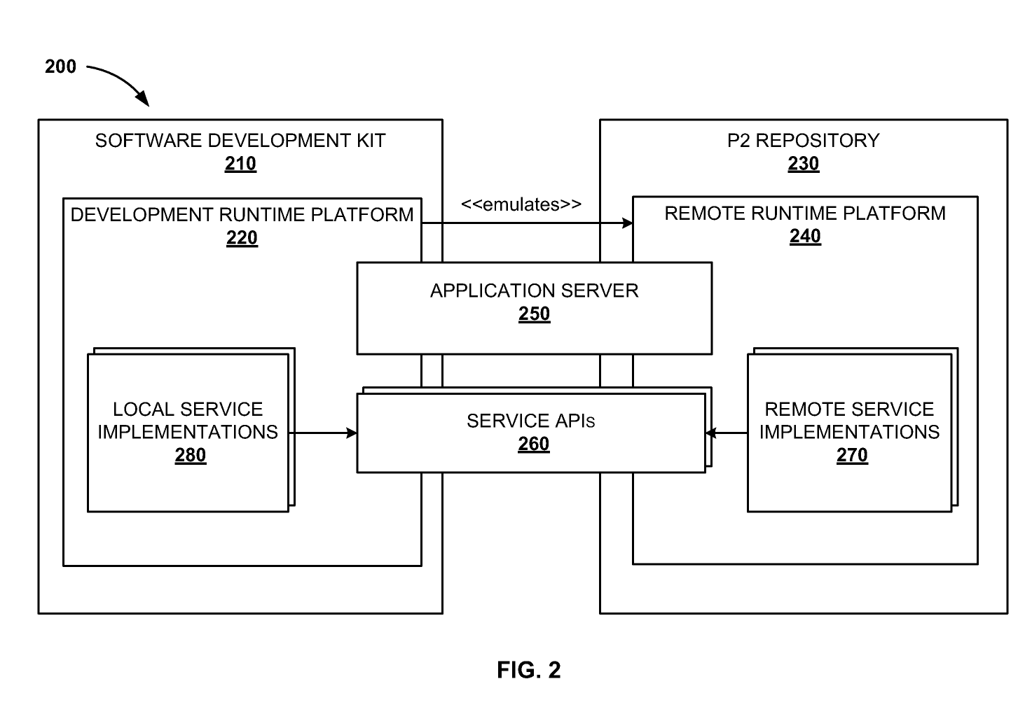

FIG. 2 illustrates a system landscape 200 for local and remote development of applications, according to one embodiment. Applications may be developed, built, installed, and provisioned on both a development runtime platform 220 and a remote runtime platform 240. In one embodiment, remote runtime platform 240 may be on-demand Platform-as-a-Service that is developed and supplied by a provider such as provider 101 in FIG. 1. On the other hand, the development runtime platform 220 may refer to a runtime platform that is intended for development in a local development environment of a customer of the remote runtime platform 240, e.g., customer of cloud service 145 in FIG. 1. In one embodiment, both remote runtime platform 240 and development runtime platform 220 may be based on OSGi™. Thus, both remote runtime platform 240 and development runtime platform may support the development of OSGi™ bundles.

Runtime platform 240 includes, among other components, an application server 250 as core runtime functionality such as application server 110 (FIG. 1), a number of APIs 260 of services such as services 115-125 (FIG. 1), remote service implementations 270 that implement service APIs 260, etc. Development runtime platform 220 also includes service APIs 260 and application server 250. However, in development runtime platform 220, service APIs 260 may be differently implemented, for example, local service implementations 280 may implement service APIs 260, according to one embodiment. Local service implementations 280 are intended for development, installing, and testing of applications in a local development environment of a customer of the remote runtime platform 240. Generally, local service implementations 280 differ from remote service implementations 270.

As illustrated, remote runtime platform 240 may be kept in a p2® repository 230. In one embodiment, p2® provisioning mechanism builds installation data of runtime platform 240 and publishes it in p2® repository 230. The installation data includes artifacts (e.g., code or binaries) and metadata describing the artifacts, e.g., the relationships and dependencies between them, their default properties, configuration data, scripts, etc. The p2® repository 230 may be stored in any memory location.

In one embodiment, a software development kit (SDK) such as SDK 210 may include development runtime platform 220. The SDK 210 may be self-contained and without any dependencies to external sources. Necessary content for the proper functioning of the development runtime platform 220 is included in the SDK 210, for example, content that is provided from external sources is replicated and included in SDK 210. In addition to the development runtime platform 220, SDK 210 may also include a p2® repository of the development runtime platform 220 that includes an Eclipse® update site of the development runtime platform 220, command line tools, Java® documentation, licenses, and so on. According to Eclipse® terminology, an Eclipse® update site is used to organize and export plugins, features, and other packages so they can be installed into Eclipse® applications. When an update site is built, the included features in the update site, along with plugins part of those features, are exported into an installable form.

In one embodiment, SDK 210 and p2® repository 230 are generated as a result of building and publishing a single software development project such as an Eclipse® project or Maven™ project. Maven™ is a software project management tool provided by the Apache™ Software Foundation (ASF).The project may be kept on a memory location maintained by the provider of the runtime platform 240 or a third party. An example of such memory location is a Nexus™ directory location. Nexus™ is a tool for repository management providing techniques to proxy remote repositories and share software artifacts. Services may be developed as sub-projects part of this development project and may be kept in the same location. In one embodiment, as part of each service sub-project, two features representing the corresponding service are created, one feature for development runtime platform 220 and one feature for the remote runtime platform 240. For example, if a sub-project for a persistency service is created, this persistency sub-project may include a “persistency.SDK.feature” and a “persistency.jpaas.feature”. As a result of publishing the development project that includes the services' sub-projects, features of the services intended for the development runtime platform are included in SDK 210 and features of the services intended for the remote runtime platform are included in p2® repository 230. Generating SDK 210 as part of the same project of the remote runtime platform 240 enables correspondence between development runtime platform 220 and remote runtime platform 240. Based on such correspondence, functioning of applications in the development runtime platform 220 may emulate functioning of applications in the remote runtime platform 240.

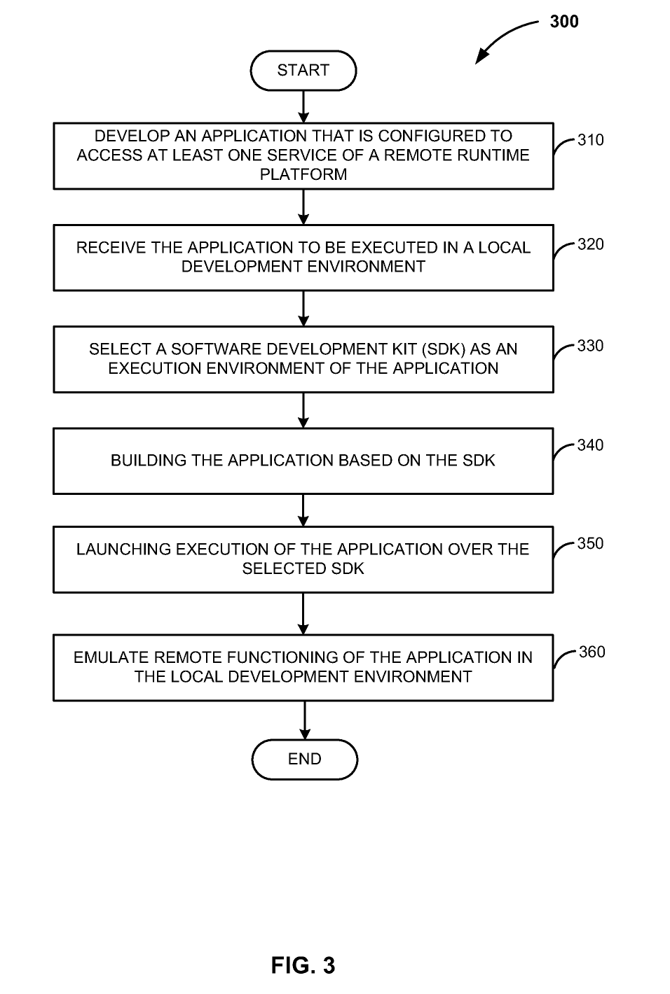

A customer of remote runtime platform 240 may develop an application to be deployed, installed, and provisioned on remote runtime platform 240. In one embodiment, before a customer application is deployed onto and provisioned by remote runtime platform 240, the functioning of the application may be emulated in a local development environment such as development runtime platform 220. FIG. 3 illustrates process 300 for emulating in a local development environment the functioning of an application on a remote runtime platform, according to one embodiment.

At 310, a computer application is developed. In one embodiment, a customer of a remote runtime platform develops an application to be deployed and installed on the remote runtime platform. The computer application may be configured to access at least one service from a number of services of the remote runtime platform, e.g., services 115-125 in FIG. 1. In one embodiment, the remote runtime platform and the at least one service may be part of a cloud infrastructure. At 320, the application is received for execution in a local development environment. The local development environment may refer to the application development workspace that for example may be stored, in a local host computer. Sources of the application may be stored, compiled, built, and executed in a memory location of the local host computer. In one embodiment, the local development environment may be an Eclipse® workspace.

At 330, a software development kit (SDK) is selected as an execution environment of the application, for example, SDK 210 in FIG. 1. The SDK is intended for development and testing of applications in the local development environment. The SDK includes a development runtime platform such as development runtime platform 220 in FIG. 2. The SDK may be selected as an execution environment by configuring the SDK as an active target platform. According to Eclipse® terminology, the target platform refers to the plugins against which an application development workspace will be built, compiled, launched and run against. It represents the platform that an application developer builds for. Thus, by setting the SDK as a target platform, the local development runtime platform that includes local implementations of the services is set as the execution environment of the application. In one embodiment, the SDK may be automatically retrieved. In yet another embodiment, the SDK may be manually selected.

At 340, the application is built based on the selected SDK. Sources of the application are compiled and built based on the development runtime platform. The build process manipulates the sources of the application and produces new resources of the application. Just as an example, when a build process is triggered for a Java® project, a Java® builder converts Java® source files (e.g., “.java files”) into one or more executable class files (e.g., “.class files”).

At 350, execution of the application is launched over the selected SDK. Thus, execution of the application is launched over the local development runtime platform. At 360, remote functioning of the application is emulated in the local development environment. The functioning of the application on the remote runtime platform is emulated in the local host based on the local development runtime platform. The application is executed and running based on the local development runtime platform that is set as an execution environment.

In one embodiment, remote functioning of the at least one service that the application is configured to access is emulated in the local development environment based on the local implementation of the at least one service. Thus, functioning of the service in the remote runtime platform is emulated in the local development environment. In one embodiment, in response to the execution of the application over the local development runtime platform, an API of the at least one service is accessed. Further, local implementation of the at least one service is consumed by the application. The application may be tested and validated in the local development environment before it is deployed, installed, and provisioned on the remote runtime platform. Since, the local development runtime platform emulates the remote runtime platform, proper functioning of the application can be verified in the local development environment before deployment to the remote runtime platform.

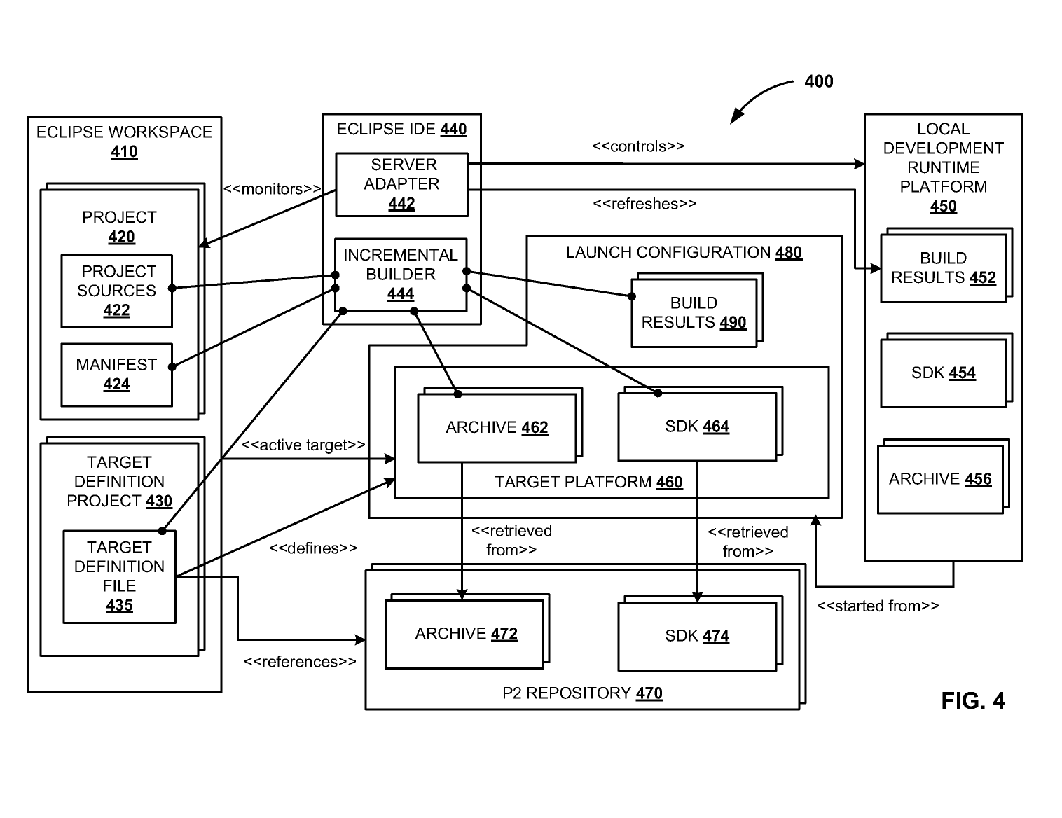

FIG. 4 illustrates an exemplary computer system landscape 400 with local development runtime platform 450 configured as an execution environment for an application to be deployed onto a remote runtime platform, according to one embodiment. A customer of the remote runtime platform may develop an application to be deployed and installed on the remote runtime platform. In one embodiment, the customer such as customer 145 in FIG. 1 may develop an application to be deployed and provisioned onto a cloud infrastructure (e.g., cloud 150 in FIG. 1). Also, the application may be configured to access at least one service of the remote runtime platform.

Typically, the customer develops, builds, tests, and executes the application in a local development environment. In one embodiment, Eclipse® IDE 440 including Eclipse® workspace 410 refers to the local development environment of the application. The application is organized and developed as project 420. Examples of such projects include, but are not limited to, Java® project, Eclipse® plugin project, Maven™ project, Eclipse® Tycho project and the like. Project 420 also maintains a model of its contents. This model represents information about the type hierarchy, references and declarations of the application's components.

Project 420 further contains source code and related files for building the application. Project sources 422 represent source code files that are part of project 422. In one embodiment, project 420 may act as source container and directly contain project sources 422. In yet another embodiment, source folders part of project 420 may be source containers and may keep project sources 422. In one embodiment, project 420 may be defined as an OSGi™ bundle.

Project 420 may also contain manifest file 424. According to Java® terminology, a manifest file is a file containing metadata and is created for a specific JAR archive file. A manifest file is used to define extension and package-related data of the JAR file for which it is created. A manifest file contains name-value pairs organized in different sections. In one embodiment, manifest file 424 describes metadata of project 420. The manifest file may specify all the classes or other sources that need to be loaded for an application to be able to run properly. Other elements contained in project 420 may include, but are not limited to; a “.project” file that describes a project and is automatically generated in response to the creation project; a “.classpath” file that specifies where on the file system classes or other sources of a project are located; a “pom.xml” file that represents an XML description of a Maven™ project including configuration information used by Maven™ to build the project, and so on.

In one embodiment, target platform 460 is defined in a target definition project 430. Target definition project 430 includes a target definition file 435. Target definition file 435 describes target platform 460. For example, target definition file 435 may describe locations' settings of the target platform. Such settings may specify various locations that include plugins, bundles, packages, and other sources to be installed and included in the target platform. Example of locations that may be specified in target definition file include, but are not limited to, p2® or other repositories, directories, installations, update or other sites such as a web site, file systems, and so on. As illustrated in FIG. 4, target definition file 435 references p2® repository 470 that includes sources to be included in target platform 460.

Target definition file 435 may further describe content settings of the target platform 460. By customizing content settings in the target definition file 435 plugins, bundles, packages, and other sources found in the specified locations may be chosen and selected to be included in the target platform. In one embodiment, target definition file 435 configures or defines SDK 474 as an Eclipse® target platform such as target platform 460. Since, SDK 474 includes a development runtime platform such as such as development runtime platform 220 in FIG. 2, the development runtime platform is set and configured as an Eclipse® target platform.

Target definition file 435 may also describe environment settings. For example, operating system, execution environment and other environment settings that affect how plugins, bundles, packages, and other sources of project 420 are built and run. Target definition file 435 may further specify, among other things, implicit dependencies among plugins, values of various arguments that may be used by launch configuration 480 such as values of a virtual machine that launch configuration 480 may instantiate, and so on. Target platform definition may be defined for a particular Eclipse® workspace. In one embodiment, multiple target definitions may be created. Target platform 460 refers to the currently active target definition. Target definition file 435 may be represented by a file with an extension “.target”. In on embodiment, the dependencies among different packages or bundles of project 420 are resolved based, among other things, on the active target platform 460. Further, dependencies among packages may also be resolved based on manifest file 424.

Launch configuration 480 may define various modes of launching project 420. Examples of such modes include, but are not limited to, running, debugging, profiling, and so on. Once a launch of project 420 is instantiated, a launch session is open based on launch configuration 480. In one embodiment, launch configuration 480 includes build results 490 and target platform 460. Build results 490 include files that are result of a build process of project 420. For example, in one embodiment, incremental builder 444 provided by IDE 440 may produce build results 490 based on project 420, and in particular, based on project sources 422 and manifest 424. In another embodiment, other build tool other than Eclipse® incremental builder 444 may be used such as Maven™ or Eclipse® Tycho builders. Launch configuration 480 may be used to launch, run, debug, test, etc., project 420. Based on launch configuration 480, SDK 474 and archive 462 are automatically retrieved from p2® repository at the local development environment.

Archive 462 and SDK 464 are retrieved from p2® repository 470 and are included in target platform 460. Archive 462 may be a local copy of archive 472 and SDK 464 may be a local copy of SDK 474. P2® repository 470 may be stored on a server or other shared memory location which, for example, may be maintained by the runtime platform provider. SDK 464 includes a development runtime platform to be started as local development runtime platform 450. Thus, SDK 464 includes, among other components, local implementations of services of the remote runtime platform, APIs of the services, an application server, and so on. On the other hand, archive 462 may include additional bundles, plugins, or other packages that may be necessary for the functioning of project 420, but are not included in SDK 464. For example, archive 462 may contain packages that are used by the customer of the remote runtime platform and are provided by third parties, or packages that may be provided and released from other projects, and so on.

When a launch of project 420 is instantiated based on launch configuration 480, local development runtime platform 450 is installed and started from launch configuration 480. Local development runtime platform 450 includes build results 452, SDK 454, and archive 456 that are installed and started from build results 490, SDK 464, and archive 462, respectively. Ultimately, the application is installed and running based on the local development runtime platform 450, which is set as an execution environment. Based on the local development runtime platform 450, remote functioning of the application is emulated in the local development environment.

Including target platform 460 in one launch configuration 480 with build results 490 has an advantage that components used for the functioning of project 420 are referenced the same way during runtime and build time. If the references are updated to point to other components or other versions of the same components, these references are updated simultaneously during both build and runtime. For example, if project 420 is updated, build results 490 included in launch configuration 480 are also updated by incremental builder 444 during build time. Also, server adapter 442 may also monitor any changes in project 420 and as a result of such changes updates and refreshes build results 452 that are included in the started and running local development runtime platform 450. Thus, the running build results 490 and build results 425 are synchronized.

In one embodiment, local development runtime platform 450 may be directly started and stopped from Eclipse® Plug-in Development Environment (PDE) using standard launch configuration. Alternatively, a server adapter such as server adapter 442 may be used to control the lifecycle of the runtime. In one embodiment, server adapter 442 may be the SAP® NetWeaver® Server Adapter that enables various IDEs, that are based on the Eclipse Web Tools Platform (WTP), to develop, deploy, run and debug Java® EE applications against the SAP® NetWeaver® Application Server.

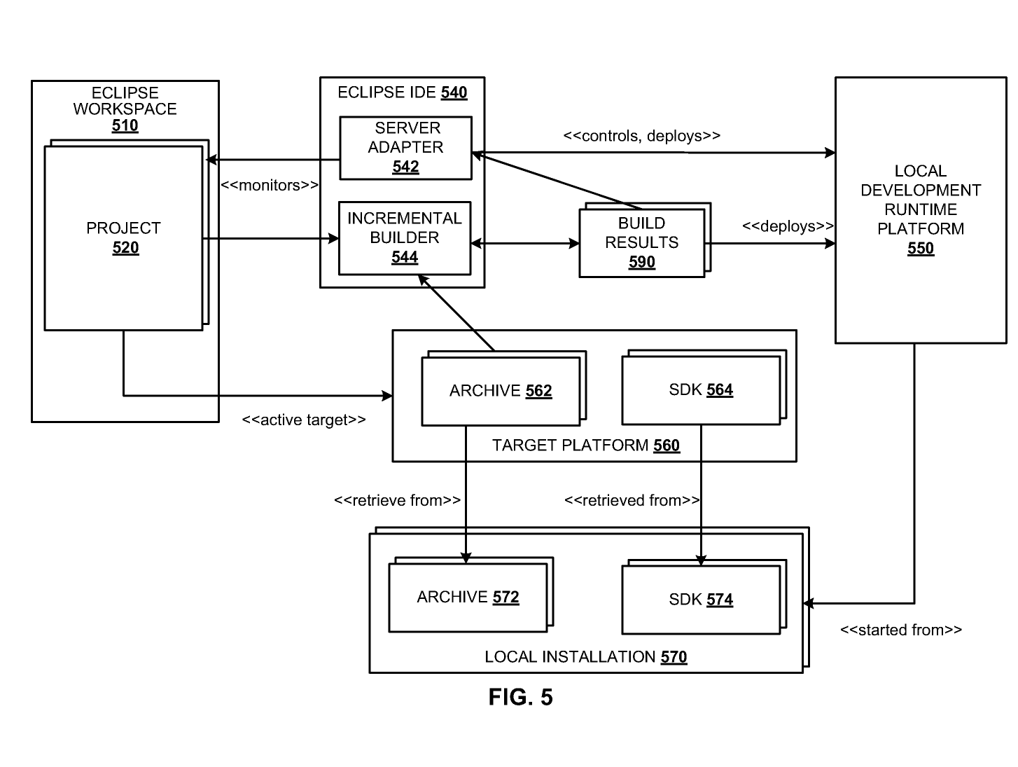

In one embodiment, other methods for configuring the local development runtime platform as an execution environment for one or more applications to be deployed on the remote runtime platform may also be used. FIG. 5 illustrates an exemplary computer system landscape 500 with installed local development runtime platform as an execution environment for an application to be deployed onto a remote runtime platform, according to one embodiment.

A customer of the remote runtime platform may develop an application to be deployed and installed on the remote runtime platform. The customer develops, builds, tests, and executes the application in Eclipse® workspace 510 of Eclipse® IDE 540. The application is developed as project 520. During build time of project 520, incremental builder 544 produces build results 590.

In one embodiment, target platform 560 is the active target definition. Archive 562 and SDK 564 are retrieved from local installation 570 and are included in the active target platform 560. Archive 562 and SDK 564 are copies of archive 572 and SDK 574, respectively that are included in local installation 570. Local installation 570 represents installation of development runtime platform such development runtime platform 220 in FIG. 2, and installation of archive 562 such as archive 462. SDK 564 includes a development runtime platform.

Local installation 570 installs the development runtime platform and archives 562 at a memory location of the local host computer of the customer that develops the application. In yet another embodiment, the installation may be located on another computer system different from the local host computer of the customer. In one embodiment, SDK 574 may be requested and retrieved from an update site of the remote runtime platform provider. Then, SDK 574 may be uploaded to a memory of the local host computer. Further, SDK 574 including archives 572 may be configured to be included in the active target platform definition, i.e. target platform 560. In one embodiment, instead of manually downloading and retrieving SDK 574 from an update site, provisioning commands via the OSGi console may be used. In another embodiment, a graphical user interface may be used for selecting SDK 574.

In one embodiment, in response to a request, server adapter 542 may populate target platform 560 from local installation 570, so that the same components are used to develop and build the application. Server adapter 542 deploys build results 590 to local development runtime platform 550 that is running Local development runtime platform 550 is started from local installation 570.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

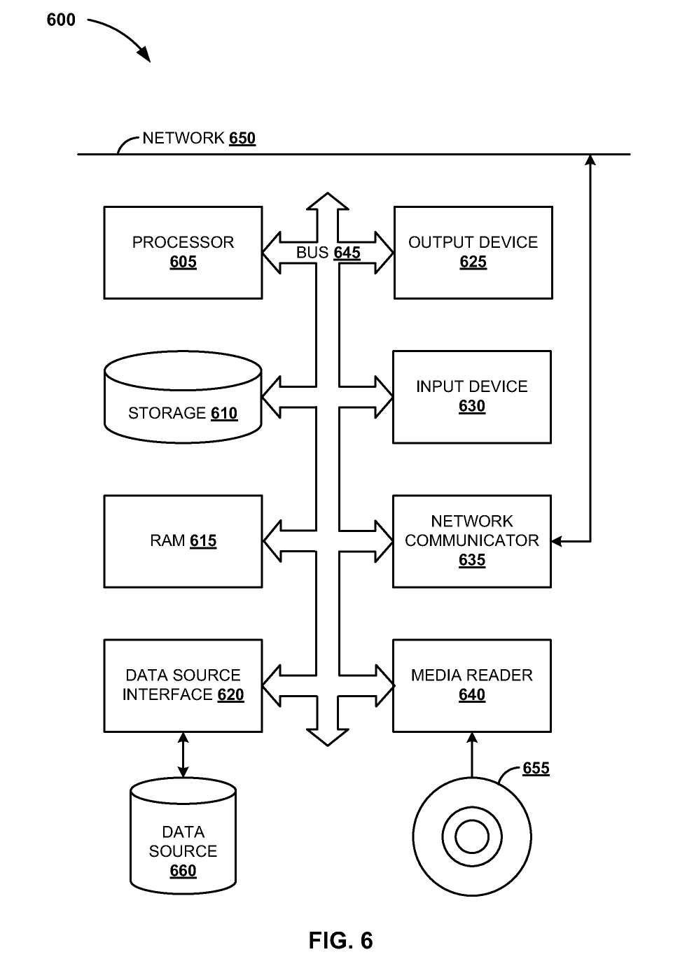

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method to emulate in a local development environment functioning of a computer application in a remote runtime platform, the method comprising:
receiving the application to be executed in the local development environment, wherein the application is configured to access at least one service from a plurality of services of the remote runtime platform;
selecting a software development kit (SDK) as an execution environment of the application, wherein the SDK including a plurality of application programming interfaces (APIs) of the plurality of services and a plurality of local implementations of the plurality of services;
launching execution of the application over the SDK; and
emulating the remote functioning of the application in the local development environment.

2. The method of claim 1, wherein emulating the functioning of the application in the local development environment further comprises:
emulating remote functioning of the at least one service in the local development environment based on a local implementation from the plurality of local implementations of the at least one service.

3. The method of claim 2, emulating the remote functioning of the application in the local development environment further comprises:
accessing an API from the plurality of APIs associated with the at least one service; and
consuming a local implementation of the at least one service by the application, wherein the local implementation of the at least one service emulates a remote implementation of a cloud service.

4. The method of claim 1, wherein selecting the SDK as an execution platform of the application further comprises further comprises:
automatically retrieving the SDK from a p2® repository at the local development environment, wherein the SDK is included in the p2® repository.

5. The method of claim 1, wherein selecting the SDK as an execution platform of the application further comprises:
requesting the SDK from an update site, wherein the SDK is associated with the update site;
uploading the SDK to a memory of the local host; and
setting the SDK as a target platform, wherein the application to be run on the target platform.

6. The method of claim 1, further comprising:
building the application in the local development environment; and
testing the application in the local development environment based on the SDK.

7. The method of claim 1, further comprising:
deploying the application to the remote runtime platform; and
executing the application in the remote runtime platform.

8. A computer system to emulate in a local development environment functioning of a computer application in a remote runtime platform, the system including:
at least one processor and memory to execute program code related to:
receive the application to be executed in the local development environment, wherein the application is configured to access at least one service from a plurality of services of the remote runtime platform;
select a software development kit (SDK) as an execution environment of the application, wherein the SDK including a plurality of application programming interfaces (APIs) of the plurality of services and a plurality of local implementations of the plurality of services;
launch execution of the application over the SDK; and
emulate the remote functioning of the application in the local development environment.

9. The system of claim 8, wherein the program code further relates to:
emulate remote functioning of the at least one service in the local development environment based on a local implementation from the plurality of local implementations of the at least one service.

10. The system of claim 9, wherein the program code further relates to:
access an API from the plurality of APIs associated with the at least one service; and
consume a local implementation of the at least one service by the application, wherein the local implementation of the at least one service emulates a remote implementation of a cloud service.

11. The system of claim 8, wherein the program code further relates to:
retrieve automatically the SDK from a p2® repository at the local development environment, wherein the SDK is included in the p2® repository.

12. The system of claim 8, wherein the program code further relates to:
request the SDK from an update site, wherein the SDK is associated with the update site;
upload the SDK to a memory of the local host; and
set the SDK as a target platform, wherein the application to be run on the target platform.

13. The system of claim 8, wherein the program code further relates to:
build the application in the local development environment; and
test the application in the local development environment based on the SDK.

14. A non-transitory computer readable medium storing instructions thereon, which when executed by a processor cause a computer system to:
receive an application to be executed in a local development environment, wherein the application is configured to access at least one service from a plurality of services of a remote runtime platform;
select a software development kit (SDK) as an execution environment of the application, wherein the SDK including a plurality of application programming interfaces (APIs) of the plurality of services and a plurality of local implementations of the plurality of services;
launch execution of the application over the SDK; and
emulate the remote functioning of the application in the local development environment.

15. The computer readable medium of claim 14, wherein emulating the functioning of the application in the local development environment further comprises:
emulating remote functioning of the at least one service in the local development environment based on a local implementation from the plurality of local implementations of the at least one service.

16. The computer readable medium of claim 15, emulating the remote functioning of the application in the local development environment further comprises:
accessing an API from the plurality of APIs associated with the at least one service; and
consuming a local implementation of the at least one service by the application, wherein the local implementation of the at least one service emulates a remote implementation of a cloud service.

17. The computer readable medium of claim 14, wherein selecting the SDK as an execution platform of the application further comprises further comprises:
automatically retrieving the SDK from a p2® repository at the local development environment, wherein the SDK is included in the p2® repository.

18. The computer readable medium of claim 14, wherein selecting the SDK as an execution platform of the application further comprises:
requesting the SDK from an update site, wherein the SDK is associated with the update site;
uploading the SDK to a memory of the local host; and
setting the SDK as a target platform, wherein the application to be run on the target platform.

19. The computer readable medium of claim 1 further comprising:
building the application in the local development environment; and
testing the application in the local development environment based on the SDK.

20. The computer readable medium of claim 14, further comprising:
deploying the application to the remote runtime platform; and
executing the application in the remote runtime platform.
